(19) United States
(12) Patent Application Publication
(10) Pub. No.: US 2026/0335996 A1
(43) Pub. Date: Oct. 29, 2026

(54) MITER SAW

(71) Applicant: MILWAUKEE ELECTRIC TOOL CORPORATION, Brookfield, WI (US)

(72) Inventors: Peter J. Roloff, Pewaukee, WI (US); James C. Sitter, Milwaukee, WI (US); Youngwon A. Kim, Wilmette, IL (US); David S. Koper, Milwaukee, WI (US)

(21) Appl. No.: 19/657,574

(22) Filed: Apr. 24, 2026

Related U.S. Application Data
(60) Provisional application No. 63/794,469, filed on Apr. 25, 2025.

(51) Int. Cl. B23D 45/04

(52) U.S. Cl. CPC B23D 45/048

(57) ABSTRACT

A miter saw including a turntable rotatably coupled to a base, a cutting assembly coupled to the turntable and including a motor configured to rotate a saw blade, a miter detent override assembly coupled to the turntable and configured to position the turntable at a plurality of predetermined positions, the miter detent override assembly including a miter angle detent assembly, a miter angle detent override, and a miter angle lock, a miter scale adjustment assembly coupled to the base and operable to adjust a position of the turntable relative to the base and along an adjustment direction, the miter scale adjustment assembly including a scale coupled to the base and including recesses defining miter angle positions, the miter angle detent assembly at least partially positionable in the recesses, and a miter scale adjustment dial coupled to the base and engaging the scale to translate the scale relative to the base.

### CROSS-REFERENCE TO RELATED APPLICATIONS

This application claims priority to U.S. Provisional Patent Application No. 63/794,469, filed on Apr. 25, 2025, the entire content of which is incorporated herein by reference.

### FIELD OF THE INVENTION

The present disclosure relates to power tools, and more particularly, to a miter saw.

### SUMMARY OF THE INVENTION

The present disclosure provides, in one aspect, a miter saw including: a base having a recessed portion positioned between a first side support and a second side support; a turntable at least partially positioned in the recessed portion and coupled to the base and rotatable about a miter axis; a cutting assembly coupled to the turntable, the cutting assembly including a motor configured to rotate a saw blade; a miter detent override assembly coupled to the turntable and configured to engage the base to position the turntable a plurality of predetermined positions relative to the miter axis, the miter detent override assembly including a miter angle detent assembly configured to selectively position the turntable at one of a plurality of predefined miter angle positions, a miter angle detent override configured to selectively disengage the miter angle detent assembly, a miter angle lock coupled to the turntable and configured to engage the base to lock a miter angle of the turntable; and a miter scale adjustment assembly coupled to the base and operable to adjust a position of the turntable relative to the base and along an adjustment direction, the miter scale adjustment assembly including a scale coupled to the base and including recesses defining the predefined miter angle positions, the miter angle detent assembly at least partially positionable in the recesses, and a miter scale adjustment dial coupled to the base and engaging the scale to translate the scale relative to the base.

The present disclosure provides in another aspect, a miter saw including: a base; a turntable coupled to the base and rotatable about a miter axis; a bevel arm coupled to the turntable, the bevel arm is rotatable about a bevel axis that is perpendicular to the miter axis; a cutting assembly coupled to the bevel arm and slidable relative thereto, the cutting assembly including a cutting assembly housing including a battery coupling interface configured to removably receive a battery pack, the cutting assembly housing defining a first inlet and a second inlet through which respective first and second airflows enter the cutting assembly housing, and an outlet through which the first and second airflows exit the cutting assembly housing, a motor configured to rotate a saw blade, the motor including a stator, a rotor at least partially positioned within the stator that is rotatable relative to the stator, an output shaft coupled to the rotor for rotation with the rotor, and a fan coupled to rotate with the output shaft, a motor housing in which the motor is at least partially supported, the motor housing supported in the cutting assembly housing, a gear assembly configured to receive a rotational input from the output shaft and provide a rotational output to an arbor, and a saw blade coupled to the arbor that is rotatable with the arbor.

The present disclosure provides, in another aspect, a miter saw including: a base; a turntable coupled to the base and rotatable about a miter axis; a bevel arm coupled to the turntable, the bevel arm is rotatable about a bevel axis that is perpendicular to the miter axis; a cutting assembly coupled to the bevel arm and slidable relative thereto, the cutting assembly including a cutting assembly housing defining a first inlet configured to receive a first airflow and a second inlet configured to receive a second airflow, and an outlet through which the first and second airflows exit the cutting assembly housing, a motor supported in the cutting assembly housing and configured to rotate a saw blade, the motor including a stator, a rotor at least partially positioned within the stator that is rotatable relative to the stator, an output shaft coupled to the rotor for rotation with the rotor, and a fan coupled to rotate with the output shaft, the first airflow and the second airflow directed through the cutting assembly housing to the outlet, a gear assembly configured to receive a rotational input from the output shaft and provide a rotational output to an arbor, and a saw blade coupled to the arbor that is rotatable with the arbor.

Other features and aspects of the subject matter will become apparent by consideration of the following detailed description and accompanying drawings.

### BRIEF DESCRIPTION OF THE DRAWINGS

FIG. 1 is a perspective view of a power tool embodied as a miter saw.

FIG. 1A is a top view of the miter saw of FIG. 1

FIG. 2 is a perspective view of a portion of the miter saw of FIG. 1, including the base.

FIG. 3 is a section view of the miter saw of FIG. 1 along section 3-3 of FIG. 1A.

FIG. 4 is another perspective view of a portion of the miter saw of FIG. 1, including the miter lock assembly and miter angle detent override.

FIG. 5 is another perspective view of a portion of the miter saw of FIG. 1, including the miter lock assembly and miter angle detent override.

FIG. 6 is a section view of the miter saw of FIG. 1 along section 6-6 of FIG. 1A, including the miter lock assembly.

FIG. 7 is another section view of the miter saw of FIG. 1 along section 7-7 of FIG. 1A, including the miter detent override assembly.

FIG. 8 is a section view of the miter saw of FIG. 1 along section 8-8 of FIG. 1A, including another embodiment of a miter detent override assembly.

FIG. 9 is another perspective view of the miter detent override assembly of FIG. 8.

FIG. 10 is a side view of the miter detent override assembly of FIG. 8.

FIG. 10A is a perspective view of the miter detent override assembly of FIG. 10.

FIG. 11A is a section view of the miter saw of FIG. 1 along section 11A-11A of FIG. 1A.

FIG. 11B is an exploded view of a portion of the miter saw of FIG. 1, including a scale and scale adjustment dial.

FIG. 11C is a bottom view of the scale adjustment dial of FIG. 1.

FIG. 12 is another perspective view of the miter saw of FIG. 1.

FIG. 13 is a section view of the miter saw of FIG. 1 along section 13-13 of FIG. 12, including the bevel arm and turntable.

FIG. 14 is another perspective view of the miter saw of FIG. 1.

FIG. 15 is another perspective view of a portion of the miter saw of FIG. 1.

FIG. 16 is a section view of a portion of the miter saw of FIG. 1 along section 16-16 of FIG. 1A.

FIG. 17 is a section view of a portion of the miter saw of FIG. 1 along section 17-17 of FIG. 16.

Before any embodiments of the subject matter are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

### DETAILED DESCRIPTION

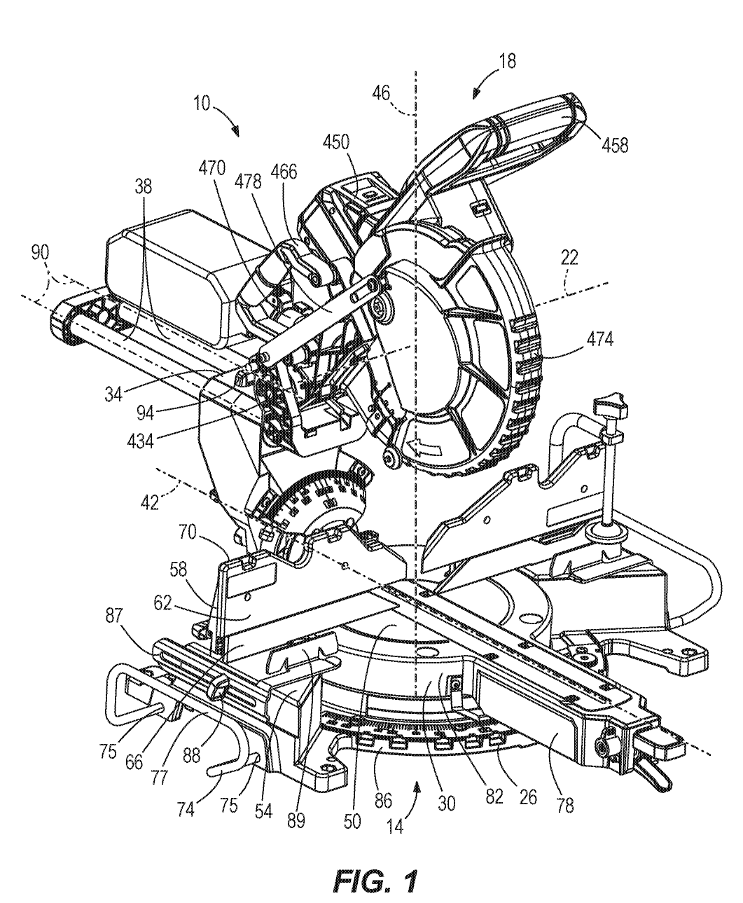

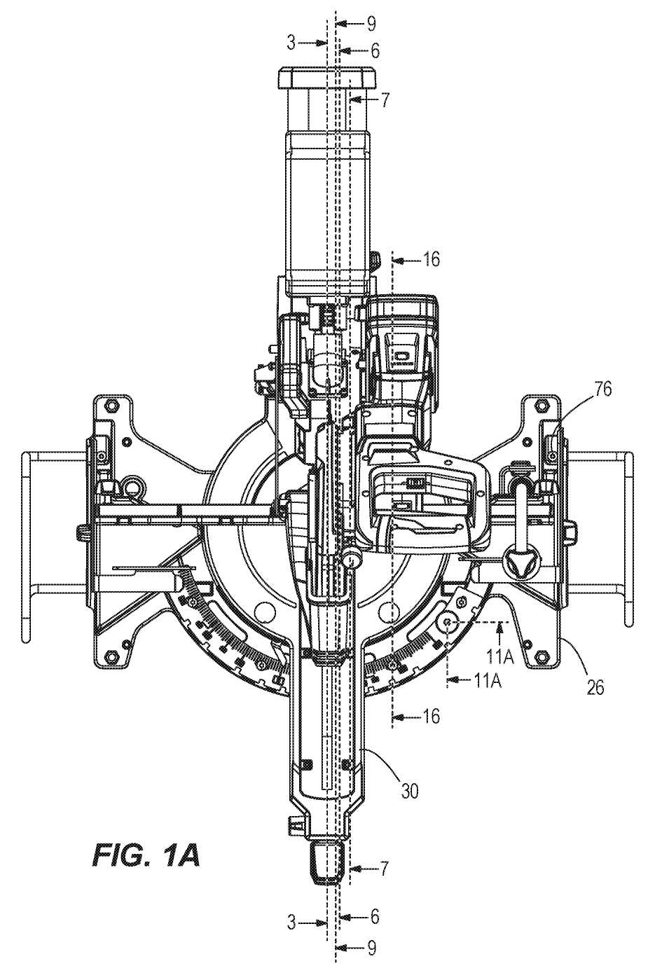

With reference to FIG. 1, a power tool 10 (i.e., a miter saw) includes a base assembly 14 and a cutting assembly 18 pivotally coupled to the base assembly 14 about a first, chopping axis 22. The base assembly 14 includes a base 26 to which a turntable 30 is pivotably coupled. A bevel arm 34 and slide rails 38 couple the cutting assembly 18 to the base assembly 14. The slide rails 38 are coupled to the cutting assembly 18 and are slidable relative to the bevel arm 34. The slide rails 38 may be supported by bearings (not shown) positioned through-holes that extend through the bevel arm 34. The bevel arm 34 is pivotally coupled to the turntable 30 about a second, bevel axis 42 and the turntable 30 is pivotally coupled to the base 26 about a third, miter axis 46. The turntable 30 defines a first support surface 50 and the base 26 defines second support surfaces 54 positioned on opposite sides of the turntable 30. The first support surface 50 and second support surfaces 54 are substantially co-planar. The base assembly 14 also includes a fence assembly 58 coupled to the second support surfaces 54 that extends over the first support surface 50 of the turntable 30. The fence assembly 58 defines stop surfaces 62 that extend perpendicular to the first support surface 50 and second support surfaces 54. The fence assembly 58 may include a stationary portion 66 coupled to the base 26 and one or more movable portions 70 coupled to the stationary portion 66 that are movable relative to the stationary portion 66 and may be removed entirely from the stationary portion 66. The base assembly 14 may also include handles 74 coupled to the base 26 that are graspable by a user to transport the power tool 10. The handles 74 are wireform handles (e.g., wire bent/formed into the handle shape) that extend through holes 75 in the sides of the base 26. In some embodiments, the handles 74 may each be removably coupled to the base 26 by a fastener 76 (FIG. 1A). In the illustrated embodiment, the handles 74 are formed including a support portion 77 that is substantially parallel with the first support surface 50 and second support surfaces 54 such that a workpiece is supported by the handles 74 at an extended position from the edges of the second support surfaces 54. In other embodiments, extensions may be coupled to the base 26 that are configured to support a workpiece. The extensions may be slidable from the base 26 to support a workpiece at a distance from the second support surfaces 54. The turntable 30 includes an extension portion 78 that extends from the circular central portion 82 beyond a front edge 86 of the base 26. One or more crown stops 87 may be slidably coupled to the base 26. A set screw 88 is threadedly coupled to the base 26 and engages the crown stop 87 to position the crown stop 87. A stop portion 89 of the crown stop 87 provides a surface against which a workpiece (e.g., crown molding) can abut for positioning during a cutting operation. The crown stop 87 may be removable when not in use.

The cutting assembly 18, bevel arm 34, slide rails 38, and turntable 30 pivot relative to the base 26 about the miter axis 46 (a substantially vertical axis). The cutting assembly 18, bevel arm 34, and slide rails 38 pivot relative to the turntable 30 about the bevel axis 42 (a substantially horizontal axis that is co-planar with the first support surface 50 and second support surfaces 54), which is perpendicular to the miter axis 46. The slide rails 38 are slidably supported in the bevel arm 34 (e.g., by linear bearings) such that the slide rails 38 and cutting assembly 18 are slidable relative to the bevel arm 34 along a slide axis 90 defined by the slide rails 38. In the current embodiment, the slide rails 38 are positioned in a substantially horizontal manner, parallel to the first support surface 50. In other embodiments, the slide rails 38 may be positioned in a different (e.g., vertical, angled, etc.) arrangement. A slide lock 94 coupled (e.g., threadedly coupled) to the bevel arm 34 is engageable with one of the slide rails 38 to lock the position of the slide rails 38 relative to the bevel arm 34. The cutting assembly 18 is pivotable relative to the slide rails 38 about the chopping axis 22, which is arranged perpendicular to the bevel axis 42 and miter axis 46. The slide lock 94 is an example of a positioning structure to position the slide rails 38 and cutting assembly 18 at a position relative to the turntable 30. The miter saw 10 may include other positioning structures (e.g., a bevel/crown stop).

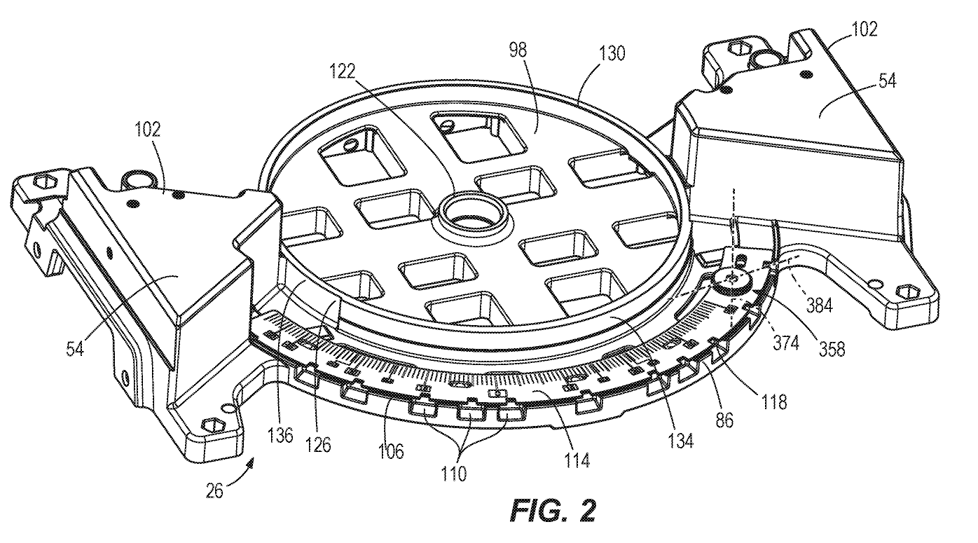

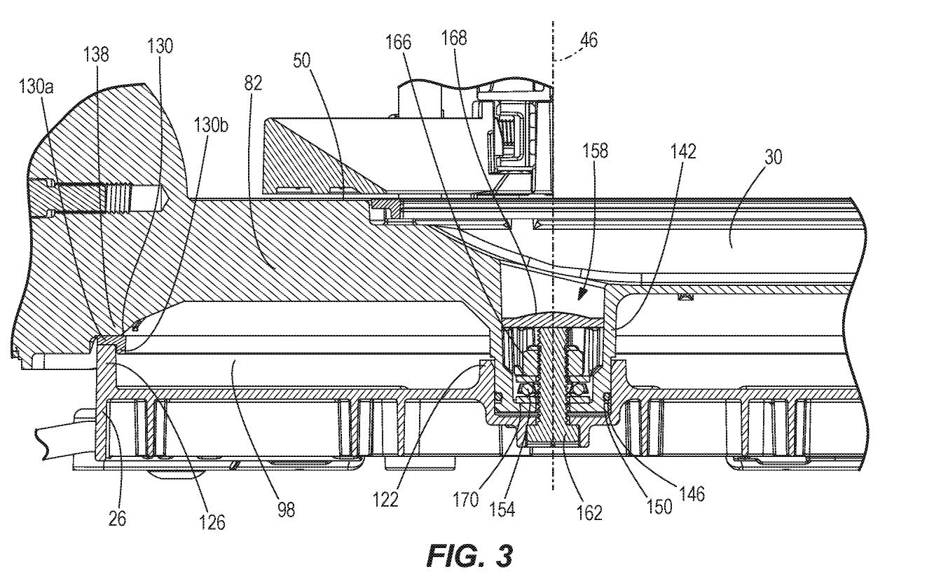

With reference to FIGS. 2 and 3, the base 26 has a substantially circular recessed portion 98 positioned between side supports 102 that define the second support surfaces 54. The front edge 86 has an arcuate shape radially outward of the substantially circular recessed portion 98 and extends between the side supports 102. The front edge 86 has a raised ridge 106 and defines a plurality of recesses 110 positioned at predefined angular positions corresponding to common miter angles (e.g., 0°, 15°, 22.5°, 31.6°, 45°, 50°). In other embodiments, the front edge 86 may not have a raised ridge. A scale 114 is coupled to the base 26 adjacent the front edge 86 and includes markings labeling the miter angle and spaces 118, or recesses, corresponding to the plurality of recesses 110. The recessed portion 98 includes a base hub 122 and a support wall 126 radially outward of the base hub 122 extending circumferentially about the recessed portion 98. A stabilizer 130 is coupled to the support wall 126. The stabilizer 130 is made of polyoxymethylene (“POM”) or may instead by made of another thermoplastic or other material with a low friction coefficient. The stabilizer 130 is formed as having an L-shaped cross-section with one of the legs 130a of the stabilizer 130 extending across the support wall 126 and the other leg 130b extending downwardly into the recessed portion 98 along the inner face of the support wall 126. The stabilizer 130 extends about the miter axis 46 through at least 180-degrees. In the illustrated embodiment, the stabilizer 130 is a singular piece that extends 360 degrees about the miter axis 46. In other embodiments, the stabilizer 130 may include multiple pieces that are positioned equidistantly or asymmetrically about the miter axis 46. A wear plate 134 is coupled to a front, outer face 136 of the support wall 126 facing the front edge 86.

With reference to FIG. 3, the circular central portion 82 of the turntable 30 has an outer wall 138 positioned radially outward of a turntable hub 142. The turntable hub 142 extends downward (i.e., in a direction away from the first support surface 50) and is positioned in the base hub 122. An O-ring 146 is positioned in a groove 150 extending about the turntable hub 142. A bearing 154 is positioned in a bore 158 extending in the turntable hub 142. The turntable 30 is coupled to the base 26 by a bolt 162 coupled to the base 26 and extending through the base hub 122 and the turntable hub 142. A nut 166 is threaded on the bolt 162 and the bearing 154 is positioned between the nut 166 and a bottom surface 170 of the bore 158. The stabilizer 130 is positioned between the support wall 126 of the base 26 and the outer wall 138 of the turntable 30. The stabilizer 130 contacts the turntable 30 to inhibit rotation of the turntable 30 about an axis other than the miter axis 46 while providing a low friction contact between the base 26 and turntable 30. The O-ring 146 also provides a contact between the base 26 and turntable 30 to support the turntable 30 and further inhibit rotation of the turntable 30 about an axis other than the miter axis 46. By positioning the stabilizer 130 at a position radially outward of the base hub 122 corresponding to an outer periphery of the recessed portion 98 aligned with the circular central portion 82 of the turntable 30, it will be appreciated that the stabilizer 130 provides better support against rotation resulting for instance, from a user-applied moment. A dust cap 168 is also positioned in the bore 158 above the nut 166. The dust cap 168 is formed from an elastomeric material. The dust cap 168 has a circular shape and the edges of the dust cap 168 contact the interior surface of the bore 158 thereby defining a sealing interface at the contact of the bore 158 and the dust cap 168.

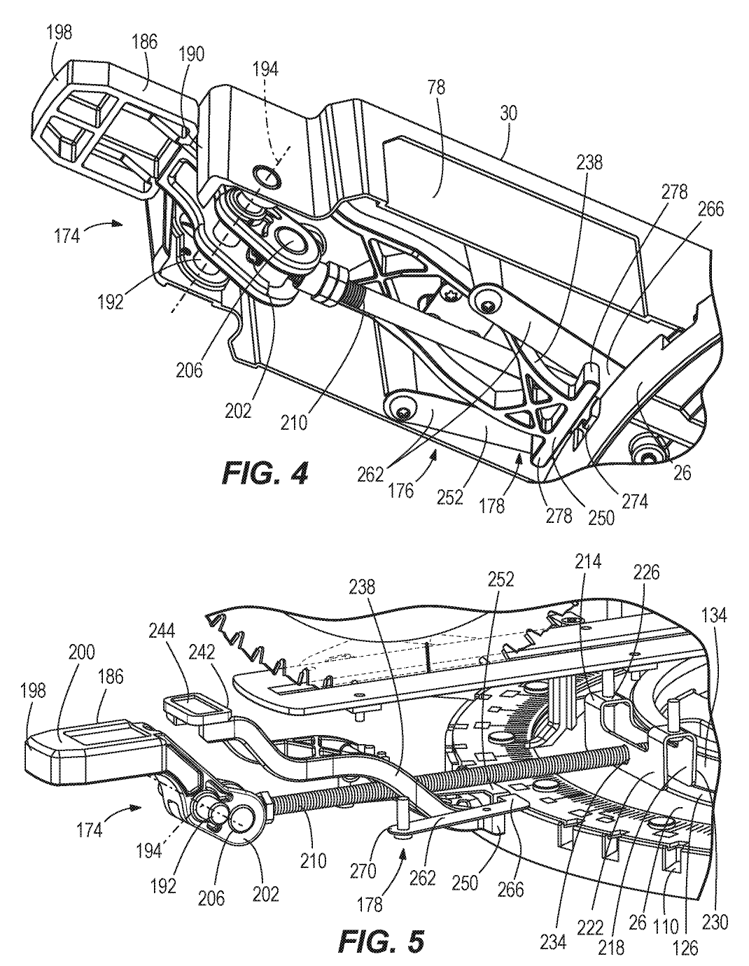

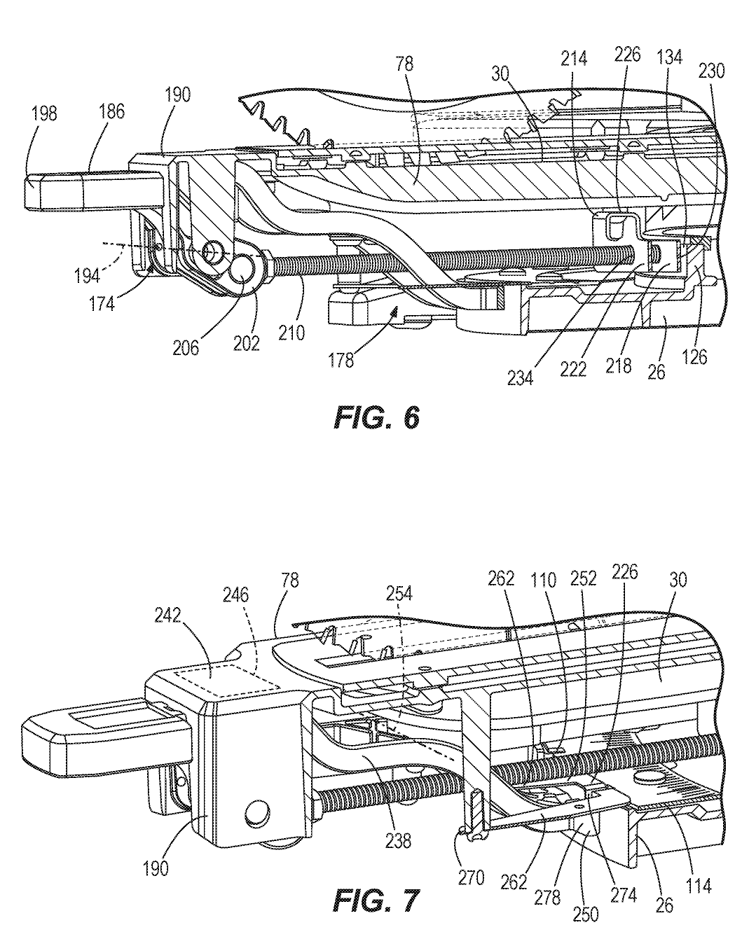

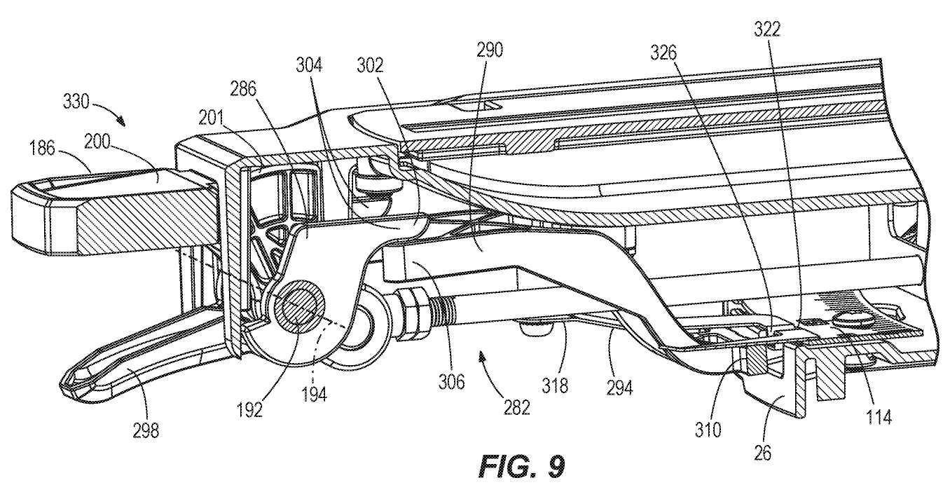

With reference to FIGS. 4-7, a miter angle lock 174 and a miter detent override assembly 176 including a miter angle detent assembly 178 for the miter saw 10 are shown. The miter angle lock 174 includes a lock lever 186 pivotally coupled at the front of the distal end 190 of the extension portion 78 by a pin 192. The lock lever 186 is pivotable about a lock pivot axis 194 of the pin 192. A first end 198 of the lock lever 186 is engageable by the user to pivot the lock lever 186 about the lock pivot axis 194. The lock lever 186 includes a pad portion 200 that is engageable (e.g., depressible) by the user to pivot the lock lever 186. The pad portion 200 extends at least partially beneath extension portion 78. The lock lever 186 may include an arcuate surface 201 (FIG. 9) extending from the pad portion 200 and corresponding to the arcuate path the lock lever 186 follows as it is pivoted. A smaller clearance is defined between the arcuate surface 201 and the extension portion 78 and reduces the gap within which a user’s finger could be pinched during rotation of the lock lever 186. The pad portion 200 may be formed with chamfered edges to further reduce the possibility of a user’s finger or other portion of the user’s hand being pinched between the lock lever 186 and the extension portion 78. With continued reference to FIGS. 4-7, an opposite second end 202 of the lock lever 186 is positioned beneath the extension portion 78 and includes a coupling rod 206. A lock rod 210 is coupled to the coupling rod 206 and extends along the extension portion 78 toward the base 26. A lock bracket 214 is coupled to the turntable 30 within the extension portion 78 adjacent the support wall 126 and wear plate 134. The lock bracket 214 includes a lock plate 218 portion and a support plate portion 222 that extend substantially parallel to one another and are joined by a joint portion 226 that is coupled to the extension portion 78. The lock plate 218 has a contact face 230 that is engageable with the wear plate 134. The support plate portion 222 includes a hole 234 through which the lock rod 210 extends.

Pivoting of the lock lever 186 about the lock pivot axis 194 in a downward direction (depicted in FIG. 5 as toward the bottom of the page) translates the lock rod 210 toward the base 26. The lock rod 210 contacts the lock plate 218 as it translates, pushing the lock plate 218 into contact with the wear plate 134, thereby locking the turntable 30 against rotation about the miter axis 46 relative to the base 26, thereby locking the miter angle of the turntable 30. Pivoting the lock lever 186 upward unlocks the miter angle lock, allowing rotation of the turntable 30 relative to the base 26.

The miter detent override assembly 176 includes a miter angle detent assembly 178 and a miter angle detent override (not shown). The miter angle detent assembly 178 includes a detent lever 238 that is pivotably coupled to the extension portion 78. A first end 242 of the detent lever 238 includes a pad portion 244 is engageable by a user through an engagement hole 246 in the extension portion 78 near the distal end 190 of the extension portion 78, adjacent the lock lever 186. The detent lever 238 extends downward and toward the base 26 to a second end 250 that engages a detent plate 252. The detent lever 238 is pivotally coupled to the turntable 30 between the first and second ends 242, 250 and rotates relative to the turntable 30 about a pivot axis 254. The miter angle detent assembly 178 also includes a detent plate 252. The detent plate 252 includes a pair of arms 262 that extend away from a detent portion 266. The arms 262 each have a distal end 270 coupled to the extension portion 78 at a position forward of the base 26. The detent portion 266 has a downwardly extending detent 274 that is selectively positionable in any of the plurality of recesses 110 of the base 26. The second end 250 of the detent lever 238 is positioned below the detent plate 252 adjacent the detent portion 266, with extensions 278 of the detent lever 238 engaging the detent plate 252.

When the turntable 30 is aligned at one of the predefined miter angles, the detent 274 is positioned in one of the plurality of recesses 110 and without intervention by a user, the downwardly extending detent 274 remains in one of the plurality of recesses 110. To position the turntable 30 at a different one of the plurality of recesses 110, a user depresses the pad portion 244 at the first end 242 of the detent lever 238. Depression of the pad portion 244 rotates the detent lever 238 about the pivot axis 254, pivoting the second end 250 upward. Engagement of the extensions 278 with the detent plate 252 raises the detent portion 266 by elastic deformation (i.e., bending) of the arms 262 of the detent plate 252. Upward pivoting of the detent portion 266 under the force applied by the detent lever 238 selectively removes the detent portion 266 from the recess allowing pivoting of the turntable 30 relative to the base 26.

In some embodiments, the miter detent override assembly 176 also includes a miter angle detent override configured to engage the detent lever 238 to maintain the detent 274 in a position removed from one of the recesses 110.

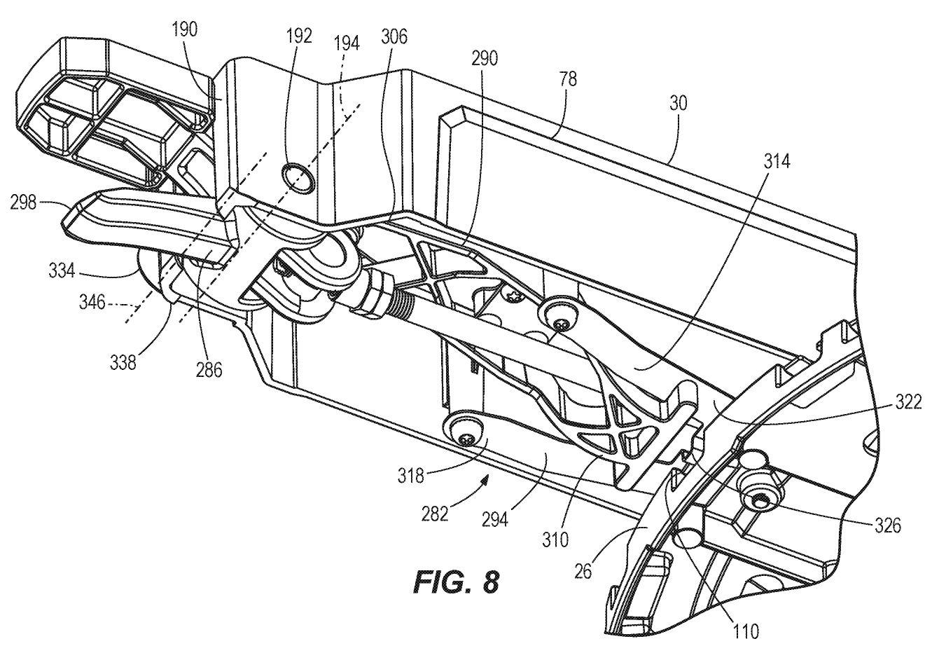

FIGS. 8-10A illustrate another embodiment of a miter detent override assembly 282 coupled to the turntable 30 and configured to engage the plurality of recesses 110 in the base 26.

The miter detent override assembly 282 includes a detent lever 286, a swing arm 290, and a detent plate 294 coupled to the extension portion 78 of the turntable 30. The detent lever 286 is pivotably coupled to the turntable 30 at the pin 192 to rotate about the lock pivot axis 194. The detent lever 286 includes a first portion 298 (e.g., a handle portion) extending from the distal end 190 of the extension portion 78 and a second portion 302 (e.g., an engaging portion) having two arms 304 that extend along the extension portion 78 toward the base 26. The swing arm 290 is pivotably coupled to the extension portion 78 rearward of the detent lever 286 and includes a first end 306 that is engageable by the second portion 302 of the lever 286. The second end 310 of the swing arm 290 extends rearward and downward below the extension portion 78 and the detent plate 294 to engage a bottom surface 314 of the detent plate 294. The detent plate 294 is coupled at a first end 318 to the extension portion 78 forward of the base 26. The opposite second end 322 of the detent plate 294 extends toward and over the base 26 and includes a detent 326 that is positionable in one of the recesses 110. In the present embodiment, detent plate 294 is substantially similar to detent plate 252.

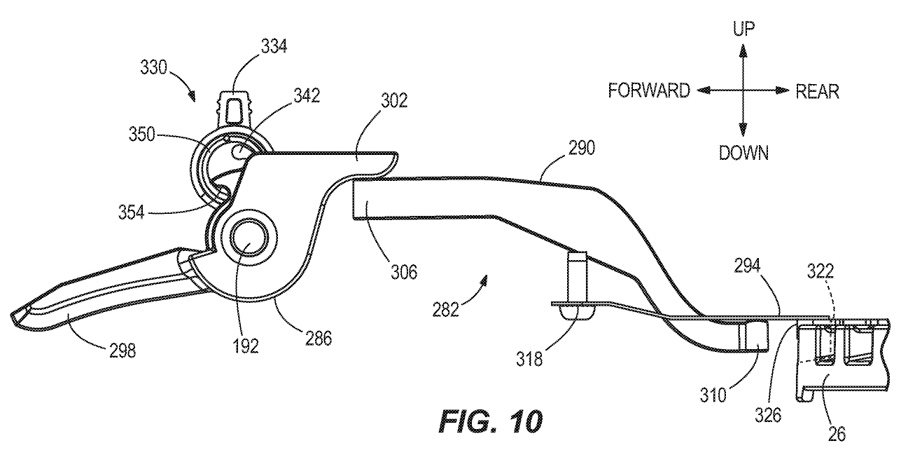

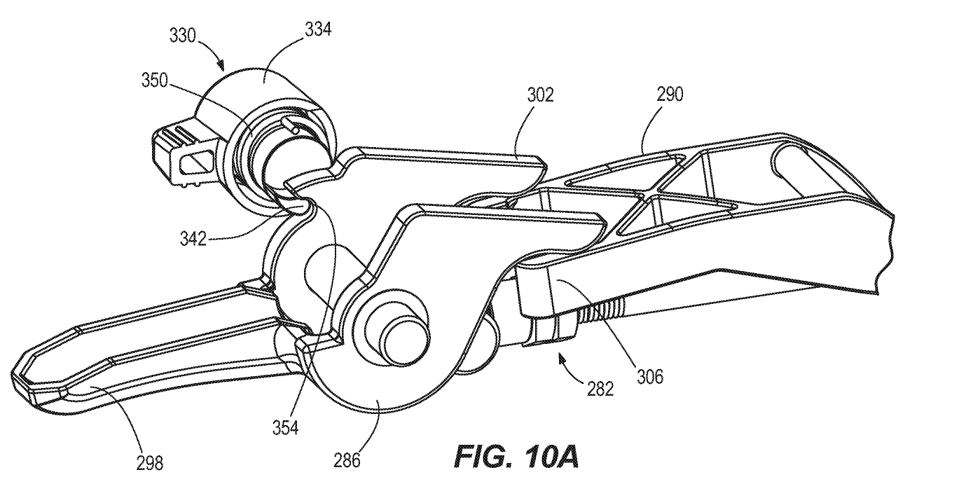

User engagement of the detent lever 286 (e.g., pulling the first portion 298 in an upward direction from the engaged position shown in FIG. 10 to the disengaged position shown in FIG. 10A) pivots the detent lever 286 about the lock pivot axis 194, engaging the second portion 302 of the detent lever 286 with the first end 306 of the swing arm 290, causing the swing arm 290 to pivot in an opposite rotational direction. Pivoting of the swing arm 290 elastically deforms the detent plate 294, raising the detent 326 of the detent plate 294 and removing the detent 326 from the recess 110 to allow for rotation of the turntable 30 to a different miter angle. Upon the user releasing the detent lever 286, the detent plate 294 elastically recovers toward its original, unbent position, which biases the detent lever 286 to return to the engaged position. If the detent 326 is not positioned in a recess 110, the detent 326 abuts the scale 114 until the turntable 30 is rotated to a predetermined miter angle position and the detent 326 is positioned in a recess 110.

With reference to FIGS. 10 and 10A, the miter detent override assembly 282 includes a miter angle detent override 330 including a knob 334 pivotally coupled to a side 338 of the turntable 30. The knob 334 includes a pin 342 eccentrically positioned relative to the pivoting axis 346 of the knob 334. A torsion spring 350 engages the knob 334 to bias the knob 334 to a first, disengaged position (shown in FIG. 10). To lock the miter detent override assembly 282 so that the detent 326 is removed from the plurality of recesses 110, with the detent lever 286 pivoted upward (e.g., by operation of the user), the knob 334 can be rotated toward the user so that pin 342 is positioned in a recess 354 of the detent lever 286. With the pin 342 positioned in the recess 354, the detent lever 286 counteracts the force applied by the torsion spring 350 to the knob 334, preventing the knob 334 from rotating to its original position while the detent lever 286 is also prevented from rotatably returning to its original position by positioning of the pin 342 within the recess 354.

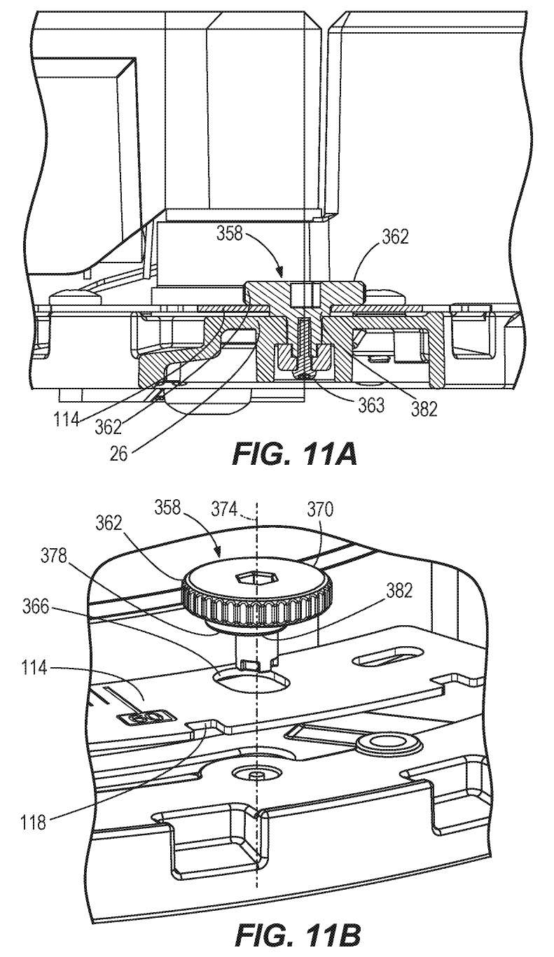

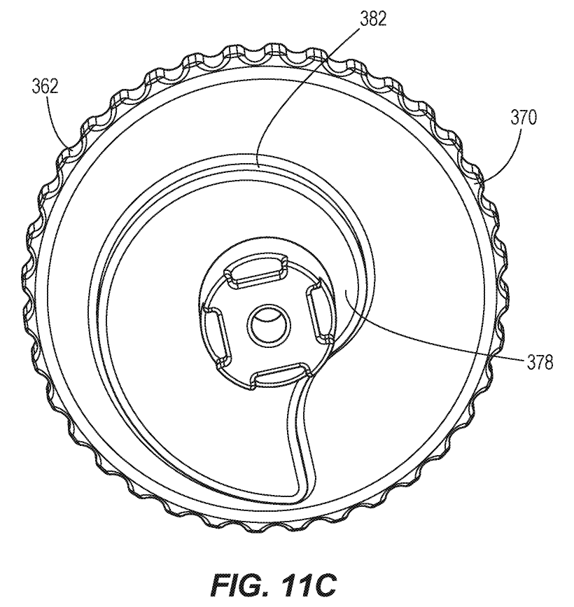

With reference to FIGS. 2 and 11A-11C, the miter saw 10 also includes a miter scale adjustment assembly 358 that is configured to adjust the position of the scale 114 relative to the base 26 in order to align the scale 114 for accurate cutting. The miter scale adjustment assembly 358 may be included with miter saws including either embodiment of a miter angle detent assembly 178, 282. The miter scale adjustment assembly 358 includes the scale 114 coupled to the base 26 and a miter scale adjustment dial 362 pivotally coupled to the base 26 by a fastener 363. The miter scale adjustment dial 362 extends through a slot 366 in the scale 114. The miter scale adjustment dial 362 includes an engaging portion 370 that is engageable by a user to rotate the 362 about a dial rotation axis 374, and a cam portion 378. The cam portion 378 has a teardrop shape having a cam surface 382 that engages the scale 114 and has a gradually increasing radius relative to the dial rotation axis 374. The engaging portion 370 may include a feature configured to receive a tool (e.g., a screw driver, a hex key, etc.) or features that are engageable by a user (e.g., ridges extending about the exterior of the engaging portion 370).

With the downwardly extending detent 274 positioned in one of the recesses 118 (e.g., the recess corresponding to a 0-degree miter angle), rotation of the miter scale adjustment dial 362 about the dial rotation axis 374 rotates the cam surface 382 such that the increasing radius of the cam surface 382 translates the scale 114 relative to the base 26 along an adjustment axis 384, and the turntable 30 with it, via engagement of the detent portion 266 with the scale 114. To calibrate the scale 114, the scale 114 must be loosened from its coupled state with the base 26 prior to translation.

In another embodiment, the miter scale adjustment dial 362 may be disposed in a recess of the turntable such that miter scale adjustment dial 362 is positioned below the first support surface 50. The engaging portion 370 may include a feature configured to receive a tool (e.g., a screw driver, a hex key, etc.) or features that are engageable by a user. The cam portion 378 engages the turntable 30, and the turntable 30 and the scale 114 move together due to the positioning of the detent portion 266 in a recess of the scale 114.

In another embodiment, the position of the scale 114 may be calibrated by positioning of the detent plate 252, 294. The detent plate 252 may be loosened relative to the turntable 30, without repositioning the scale 114. The downwardly extending detent 274 would position the turntable 30 relative to the base and the user would reposition an indicator that aligns with indicator markings on the scale 114.

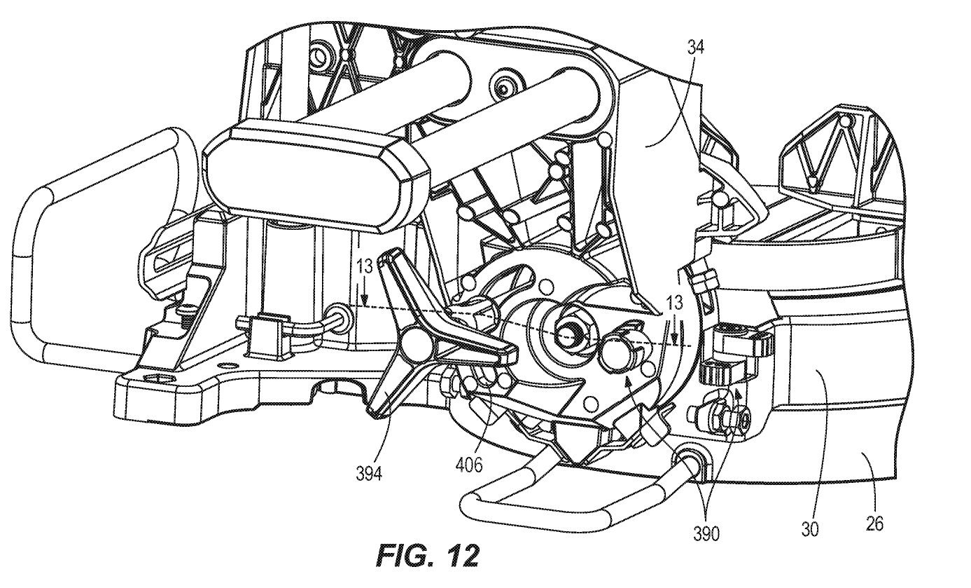

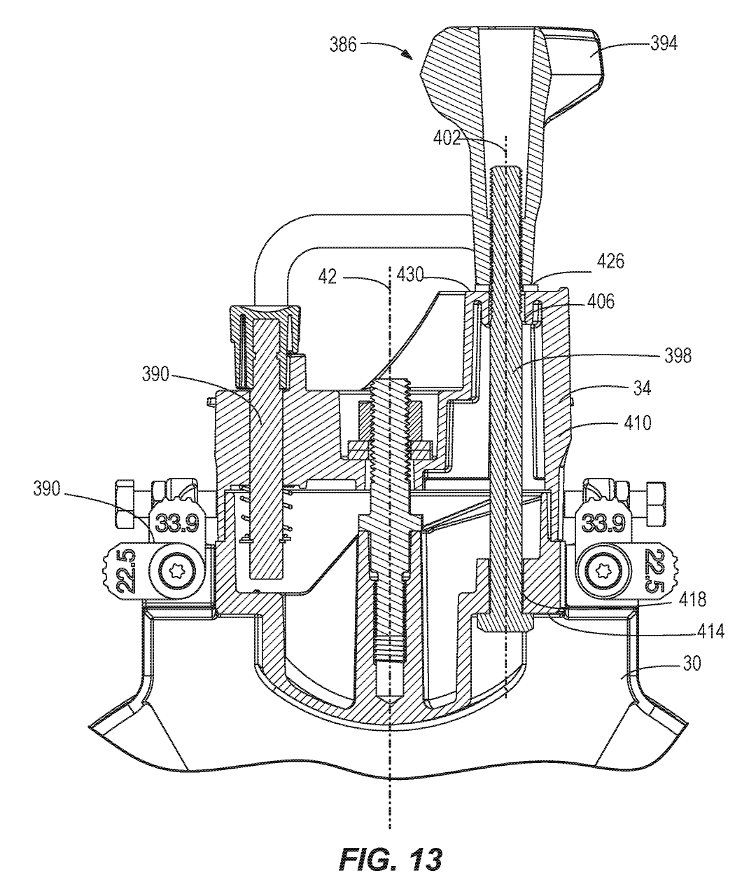

With reference to FIGS. 12 and 13, the bevel arm 34 includes a bevel lock assembly 386 that locks the bevel angle about the bevel axis 42 of the bevel arm 34 and cutting assembly 18 relative to the turntable 30 in addition to one or more bevel stops 390 configured to provide quick placement of the bevel arm 34 at a predefined bevel angle. The bevel lock assembly 386 includes a handle 394 that is graspable by the user to lock and unlock the bevel lock assembly 386. As shown in FIG. 13, a lock screw 398 extends along a bevel lock axis 402 that is offset from the bevel axis 42. In other embodiments, the lock screw 398 may extend along and define the bevel axis 42 such that the bevel arm 34 rotates about the lock screw 398. The lock screw 398 is positioned in a slot 406 that extends through a bevel support hub 410 of the bevel arm 34 positioned at a rear end 414 of the turntable 30 and through a bore 418 through the bevel arm 34. The handle 394 is threaded on the lock screw 398 to maintain the position of the lock screw 398 in the bevel support hub 410. One or more washers 426 are positioned on the lock screw 398 and engage a rear face 430 of the bevel arm 34. The handle 394 engages the one or more washers 426. Rotation of the handle 394 onto the lock screw 398 applies a force through the one or more washers 426 to frictionally engage the bevel arm 34 with the bevel support hub 410 thereby inhibiting rotation of the bevel arm 34 about the bevel axis 42.

With reference to FIGS. 1 and 14-15, the cutting assembly 18 includes a clevis 434 coupled to the slide rails 38 and a cutting assembly housing 438 that supports a saw blade 442 rotated by a motor 446 supported in the cutting assembly housing 438. The cutting assembly housing 438 is pivotable relative to the clevis 434 about the chopping axis 22. A battery pack 450 (e.g., an 18 Volt battery pack, 12 Volt battery pack, or a battery pack providing another voltage) is removably couplable to a battery coupling interface 452 defined by the battery pack attachment portion 454 of the cutting assembly housing 438 and is configured to provide a power source for the motor 446. The cutting assembly housing 438 includes a first handle 458 including a trigger switch 462 (e.g., a depressible trigger switch) configured to activate the motor 446 and operate the miter saw 10. A second handle 466 is coupled to the cutting assembly housing 438 and is configured to be grasped by a user to carry the miter saw 10 when not in use. A dust collection port 470 extends from the cutting assembly housing 438 in a rearward direction away from a user. A dust receptacle 472 may be removably couplable to the dust collection port 470. The dust collection port 470 may alternatively be couplable to a vacuum source. The dust collection port 470 and dust receptacle 472 may include coupling structures (e.g., a latch mechanism, a bayonet connection structure, a threaded collar, etc.) to maintain the dust receptacle 472 in a coupled state with the dust collection port 470. A blade guard 474 is pivotally coupled to the cutting assembly housing 438 and is coupled to the clevis 434 by a link 478 that is configured to apply a force to the blade guard 474 to raise the blade guard 474 as the cutting assembly 18 is pivoted toward the turntable 30 while performing a cutting operation to expose the saw blade 442 to performing a cutting operation.

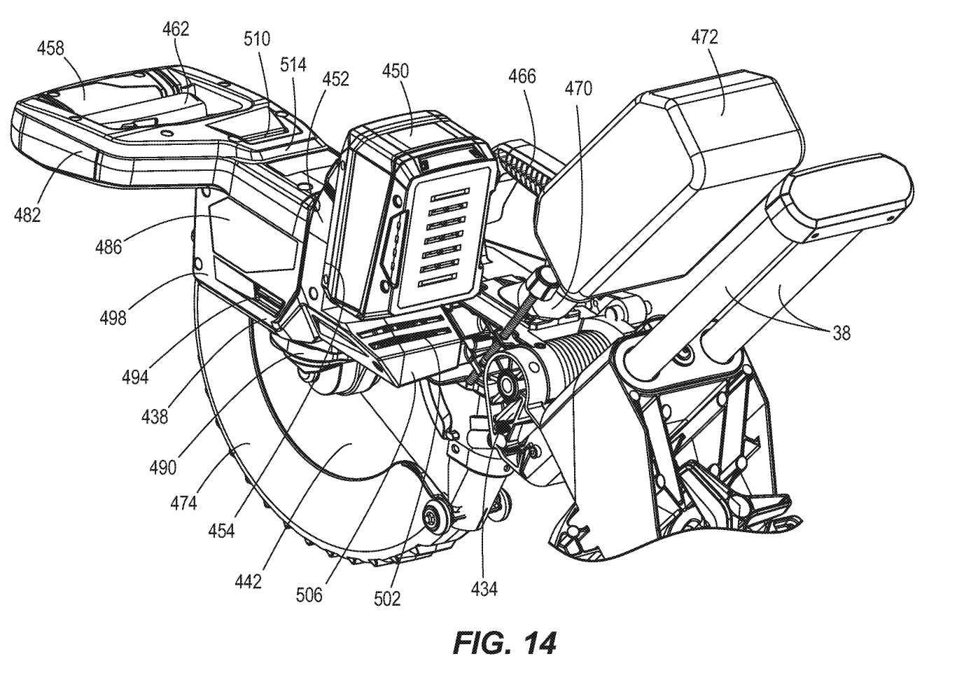

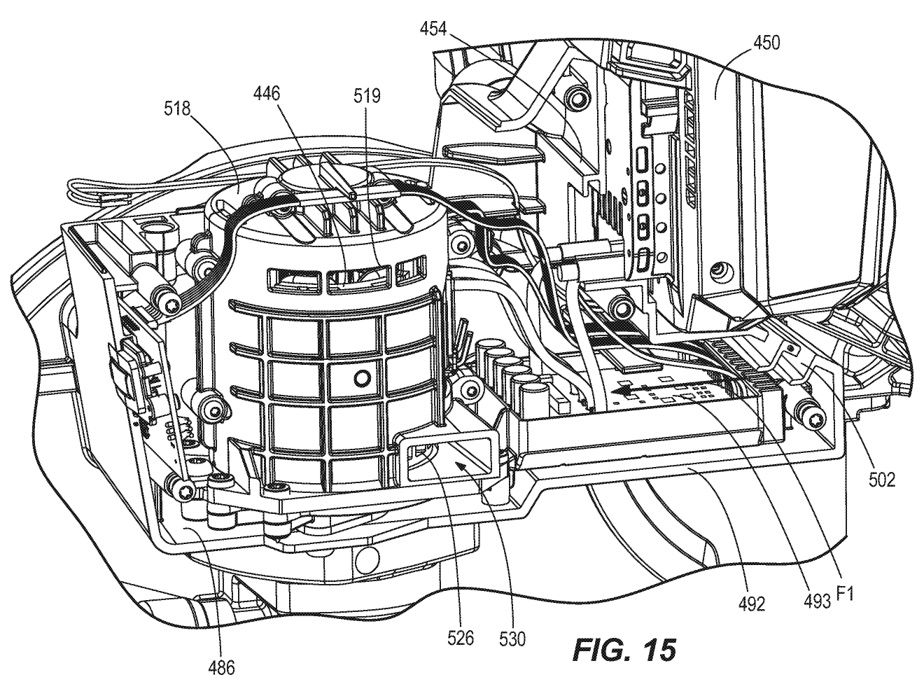

With continued referenced to FIGS. 14 and 15, the cutting assembly housing 438 includes two or more clamshell pieces that cooperate to at least partially enclose the motor 446 and form the battery pack attachment portion 454, a transmission housing portion 490, the battery pack attachment portion 454, a motor housing portion 486, and an electronic control unit support portion 492. The electronic control unit support portion 492 is a first portion of the cutting assembly housing 438. The motor housing portion 486 is a second portion of the cutting assembly housing 438. The cutting assembly housing 438 also includes a handle portion 482 defining the first handle 458. The electronic control unit support portion 492 is at the rear end 506 of the cutting assembly housing 438 adjacent the motor housing portion 486, and beneath and adjacent the battery pack attachment portion 454. The electronic control unit support portion 492 supports a printed circuit board assembly (“PCBA”) that is configured as an electronic control unit 493 configured to control operation of miter saw 10. The electronic control unit 493 is at least partially positioned beneath the battery pack attachment portion 454. An air outlet 494 is formed in a side 498 of the cutting assembly housing 438 and an air inlet 502 is formed in the electronic control unit support portion 492 at a rear end 506 of the cutting assembly housing 438 The air inlet 502 is a first air inlet. A second air inlet 510 is formed on a top surface 514 of the cutting assembly housing 438 in the motor housing portion 486.

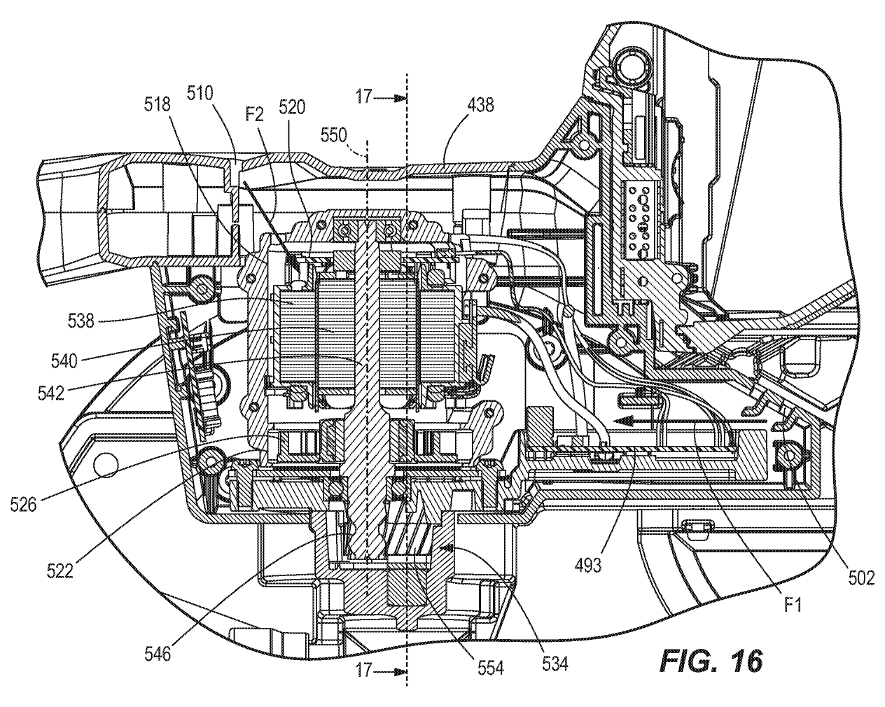

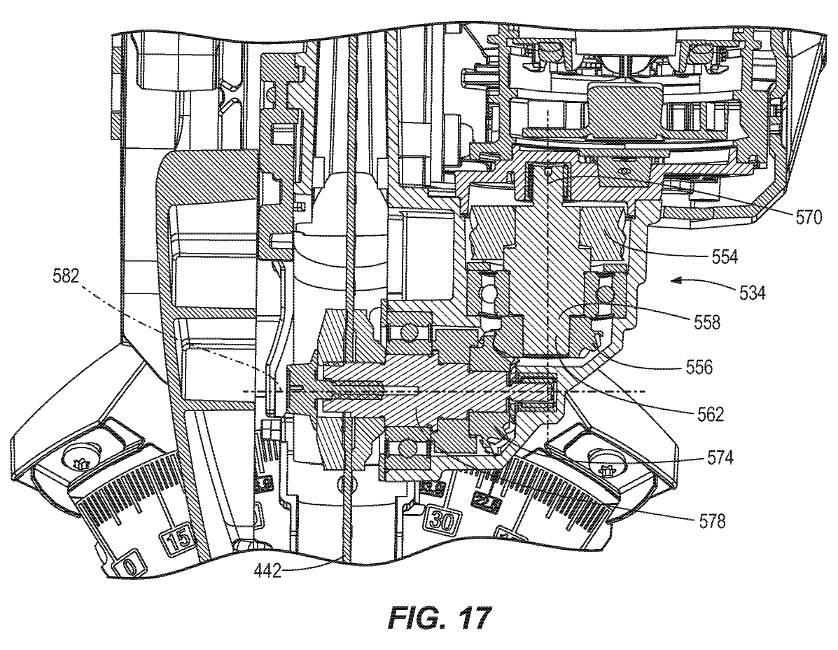

With reference to FIGS. 15-17, the motor 446 is supported in the motor housing portion 486 within a motor housing 518 that is coupled to the cutting assembly housing 438. The motor housing 518 at least partially encloses the motor 446 and includes holes 519 that permit air to flow into the motor housing 518 to cool the motor 446 and a motor electronic control unit 520 (e.g., a PCBA) electrically coupled to the motor 446 and configured to control operation of the motor 446. The motor housing 518 includes a volute portion 522 that at least partially circumferentially encloses a portion of the motor 446 and a fan 526 coupled to the motor 446. The volute portion 522 defines an outlet 530 (e.g., a second outlet) in fluid communication with the air outlet 494. In other embodiments, the motor 446 may be at least partially positioned in a baffle that is coupled to the motor housing portion 486. The baffle may at least partially circumferentially enclose a portion of the motor 446, including the fan 526, while the remainder of the motor 446 is not enclosed. The baffle may define the outlet 530 in fluid communication with the air outlet 494 and through which the airflows are directed.

The fan 526 generates a combined airflow through motor housing portion 486 such that the motor housing 518 and the motor 446 receive an airflow to cool the motor 446 and the motor electronic control unit 520. The combined airflow includes both a first airflow F1 and a second airflow F2. The first airflow F1 flows into the electronic control unit support portion 492 through the first air inlet 502 and cools the electronic control unit 493. The second airflow F2 flows into the motor housing portion 486 through the second air inlet 510. The second airflow F2 is configured as a dedicated motor cooling airflow that cools only the motor 446 and motor electronic control unit 520, while the first airflow F1 cools both the electronic control unit 493 as well as the motor 446 and the motor electronic control unit 520. The combined first and second airflows F1, F2 enter the volute portion of the motor housing 518 and are directed toward the outlet 530 of the motor housing 518.

The motor 446 is configured to provide a rotational output to drive the saw blade 442 through a gear assembly 534 supported in the cutting assembly housing 438. The motor 446 includes a stator 538 and a rotor 540 positioned within the stator 538. The rotor 540 is coupled to an output shaft 542 to which the fan 526 is coupled. The gear assembly 534 includes a helical pinion 546 coupled to the output shaft 542 for rotation with the output shaft 542 about a motor rotation axis 550. The helical pinion 546 meshes with a helical driven gear 554 coupled to an intermediate shaft 558. At an end 562 of the intermediate shaft 558 opposite the helical driven gear 554, a bevel drive gear 566 is supported on the intermediate shaft 558. The helical driven gear 554, intermediate shaft 558, and bevel drive gear 566 rotate about an intermediate rotation axis 570 positioned between the motor rotation axis 550 and the saw blade 442. The bevel drive gear 566 engages a driven gear 574 coupled to the arbor 578. The driven gear 574 and arbor 578 rotate about a cutting axis 582 that is perpendicular to the intermediate rotation axis 570. Rotation of the rotor 540 relative to the stator 538 rotates the helical pinion 546 and thereby drives the helical driven gear 554, intermediate shaft 558, and bevel drive gear 566 to rotate. Rotation of the bevel drive gear 566 drives the driven gear 574 and arbor 578 to rotate, thereby rotating the saw blade 442 to cut a workpiece.

Although the subject matter has been described in detail with reference to certain preferred embodiments, variations and modifications exist within the scope and spirit of one or more independent aspects of the subject matter as described. Various features of the subject matter are set forth in the following claims.

What is claimed is:

1. A miter saw comprising:
a base having a recessed portion positioned between a first side support and a second side support;
a turntable at least partially positioned in the recessed portion and coupled to the base and rotatable about a miter axis;
a cutting assembly coupled to the turntable, the cutting assembly including a motor configured to rotate a saw blade;
a miter detent override assembly coupled to the turntable and configured to engage the base to position the turntable a plurality of predetermined positions relative to the miter axis, the miter detent override assembly including
a miter angle detent assembly configured to selectively position the turntable at one of a plurality of predefined miter angle positions,
a miter angle detent override configured to selectively disengage the miter angle detent assembly,
a miter angle lock coupled to the turntable and configured to engage the base to lock a miter angle of the turntable; and
a miter scale adjustment assembly coupled to the base and operable to adjust a position of the turntable relative to the base and along an adjustment direction, the miter scale adjustment assembly including
a scale coupled to the base and including recesses defining the predefined miter angle positions, the miter angle detent assembly at least partially positionable in the recesses, and
a miter scale adjustment dial coupled to the base and engaging the scale to translate the scale relative to the base.

2. The miter saw of claim 1, wherein the dial includes an engaging portion that is engageable by a user to rotate the dial about a dial adjustment axis, and a cam portion having a cam surface that engages the scale, rotation of the dial about the dial adjustment axis rotating the cam surface to translate the scale.

3. The miter saw of claim 1, wherein the recessed portion has a base hub that receives a fastener coupling the turntable to the base, the miter saw further comprising a dust cap positioned in and contacting the base hub to define a sealing interface.

4. The miter saw of claim 3, wherein the dust cap is elastomeric.

5. The miter saw of claim 3, wherein the recessed portion has a support wall extending circumferentially about the recessed portion radially outward of the base hub further comprising a stabilizer coupled to the support wall and positioned between the base and the turntable, the stabilizer contacting the turntable to inhibit rotation of the turntable about an axis other than the miter axis.

6. The miter saw of claim 5, wherein the stabilizer extends at least 180 degrees about the miter axis.

7. The miter saw of claim 6, wherein the stabilizer extends 360 degrees about the miter axis.

8. The miter saw of claim 1, wherein
the miter angle lock includes
a lever rotatably coupled to an end of an extension portion of the turntable,
a lock rod coupled to the lever that is translatable relative to the turntable in response to rotation of the lever, and
a lock plate engaged by the lock rod and elastically deformable to contact the base to lock a miter angle of the turntable; and
the miter detent override assembly is configured to remove a detent from the recesses corresponding to predefined miter angles, the miter detent override assembly including
a detent lever rotatably coupled to the extension portion, the detent lever including a pad portion at a first end that is pressable by a user, and
a detent plate coupled to the extension portion, the detent plate including a detent portion extending from a plate portion, the detent plate engageable by a second end of the detent lever, the detent portion selectively positionable in one of the recesses, and
a miter detent override configured to engage the detent lever to maintain the detent portion in a position removed from one of the recesses.

9. The miter saw of claim 1, further comprising a crown stop slidably coupled to the base, the crown stop including a stop portion that is engageable with a workpiece to position the workpiece for a cutting operation.

10. A miter saw comprising:
a base;
a turntable coupled to the base and rotatable about a miter axis;
a bevel arm coupled to the turntable, the bevel arm is rotatable about a bevel axis that is perpendicular to the miter axis;
a cutting assembly coupled to the bevel arm and slidable relative thereto, the cutting assembly including
a cutting assembly housing including a battery coupling interface configured to removably receive a battery pack, the cutting assembly housing defining a first inlet and a second inlet through which respective first and second airflows enter the cutting assembly housing, and an outlet through which the first and second airflows exit the cutting assembly housing,
a motor configured to rotate a saw blade, the motor including a stator, a rotor at least partially positioned within the stator that is rotatable relative to the stator, an output shaft coupled to the rotor for rotation with the rotor, and a fan coupled to rotate with the output shaft,
a motor housing in which the motor is at least partially supported, the motor housing supported in the cutting assembly housing,
a gear assembly configured to receive a rotational input from the output shaft and provide a rotational output to an arbor, and
a saw blade coupled to the arbor that is rotatable with the arbor.

11. The miter saw of claim 10, wherein the cutting assembly housing includes an electronic control unit support portion adjacent the battery coupling interface, the first inlet disposed adjacent the battery coupling interface, the first airflow directed through the control unit support portion.

12. The miter saw of claim 11, wherein the cutting assembly housing defines a motor support portion in which the motor housing and motor are at least partially disposed, the motor support portion defining the second inlet.

13. The miter saw of claim 10, wherein the outlet is a first outlet, and wherein the motor housing defines a volute portion in which the fan is at least partially disposed, the volute portion defining a second outlet that fluidly communicates with the first outlet.

14. The miter saw of claim 10, wherein the gear assembly includes a helical pinion coupled to the output shaft, a helical driven gear engaging the helical pinion that is rotatable in response to rotation of the pinion, an intermediate shaft on which the driven gear and a bevel drive gear are supported, and a driven bevel gear coupled to an arbor that is engaged with the bevel drive gear and rotatable in response to rotation of the helical driven gear.

15. A miter saw comprising:
a base;
a turntable coupled to the base and rotatable about a miter axis;
a bevel arm coupled to the turntable, the bevel arm is rotatable about a bevel axis that is perpendicular to the miter axis;
a cutting assembly coupled to the bevel arm and slidable relative thereto, the cutting assembly including
a cutting assembly housing defining a first inlet configured to receive a first airflow and a second inlet configured to receive a second airflow, and an outlet through which the first and second airflows exit the cutting assembly housing,
a motor supported in the cutting assembly housing and configured to rotate a saw blade, the motor including a stator, a rotor at least partially positioned within the stator that is rotatable relative to the stator, an output shaft coupled to the rotor for rotation with the rotor, and a fan coupled to rotate with the output shaft, the first airflow and the second airflow directed through the cutting assembly housing to the outlet,
a gear assembly configured to receive a rotational input from the output shaft and provide a rotational output to an arbor, and
a saw blade coupled to the arbor that is rotatable with the arbor.

16. The miter saw of claim 15, wherein the cutting assembly housing includes a first portion through which the first airflow is directed and a second portion through which the first airflow and the second airflow are directed.

17. The miter saw of claim 16, wherein the motor is supported in the second portion.

18. The miter saw of claim 17, further comprising an electronic control unit supported in the first portion, the first airflow directed past the electronic control unit to cool the electronic control unit.

19. The miter saw of claim 17, further comprising a motor housing supported in the cutting assembly housing, the motor disposed at last partially within the motor housing, the motor housing receiving the first and second airflows and directing the first and second airflows to the outlet.

20. The miter saw of claim 19, wherein the fan is at least partially disposed in a volute portion of the motor housing.
